(19) United States
(12) Patent Application Publication
(10) Pub. No.: US 2017/0337747 A1
(43) Pub. Date: Nov. 23, 2017

(54) SYSTEMS AND METHODS FOR USING AN AVATAR TO MARKET A PRODUCT

(71) Applicant: Patrick M. HULL, Midlothian, VA (US)

(72) Inventor: Patrick M. HULL, Midlothian, VA (US)

(21) Appl. No.: 15/160,306

(22) Filed: May 20, 2016

(51) Int. Cl. G06T 19/20; G06Q 50/00; G06Q 30/02; G06Q 30/06; G06T 19/00; G06T 1/00

(52) U.S. Cl. CPC G06T 19/20; G06T 19/006; G06T 1/0007; G06Q 30/0277; G06Q 30/0643; G06Q 50/01

(57) ABSTRACT

Example implementations allow for augmented reality elements to be overlaid within user captured images and/or video, where the augmented reality elements may include marketing or branding messages as a part of the virtual elements. In some embodiments, the virtual elements, and the marketing or branding messages, may include one or more celebrities, sports figures, other famous figures, and/or characters. In some embodiments, an augmented reality platform is provided where a user initiates an application, for example, at a venue such as a concert or other performance event, and captures images and/or video with an augmented reality scene in place. The user may then upload the images and/or video to a social media network or otherwise share the images and/or video with friends. The augmented reality platform may include virtual elements within the enhanced images and/or video comprising a marketing or branding message for one or more products or services.

### BACKGROUND

As mobile devices have become more advanced, mobile device users more frequently interact with their environment through use of their mobile device, including capturing images and/or video of events surrounding them. With the advent of increased mobile device usage, marketers continue to seek new ways to provide marketing or branding messages to consumers through mobile device interactions. However, such marketing/branding messages are often overlooked by consumers when they do not have particular relevance to the consumer. Accordingly, systems and methods are needed that would allow for presenting marketing/branding messages that may gain more traction with a consumer, in addition to systems and methods for tracking impressions generated by such marketing/branding messages.

### SUMMARY

Some or all of the above needs may be addressed by certain implementations of the disclosed technology. Embodiments of the present invention allow for delivering and/or tracking marketing or branding messages within virtual reality or augmented reality constructs. In some embodiments, marketing or branding messages may be delivered via a celebrity, sports figure, other public figure, or character, whether real or fictional.

Embodiments may provide a platform for augmented reality where a user captures images and/or video at an event or venue with an augmented reality scene in place. The user can then upload the picture or video to a social media platform or otherwise share the image or video with friends and/or other users of the social media network. In some embodiments, the augmented reality platform may include virtual elements within the captured picture or video comprising a marketing or branding message for one or more products or services.

In an example implementation of the disclosed invention, a device is provided by which images and/or video are captured, augmented reality elements and/or scenes are generated and overlaid within the captured images and/or video, tracking elements are embedded within the enhanced images and/or video, and the enhanced images and/or video are output for display, as well as for upload to social media networks and the like. In some embodiments, the augmented reality elements and/or scenes may comprise one or more celebrities, sports figures, other famous persons, characters, or the like. In some embodiments, the embedded tracking elements may comprise one or more encoded pixels within the enhanced images and/or video. In some embodiments, the embedded tracking elements provide for capturing data in regard to the sharing of the enhanced image images and/or video across social media networks and the like.

In some embodiments, movement of the device during image and/or video capturing may be detected and the augmented reality elements and/or scenes may be modified based on the detected movement. In some embodiments, choreography changes may be received during image and/or video capturing and the augmented reality elements and/or scenes may be modified based on the choreography changes. In some embodiments, choreography changes may be received if the device is located within a specified range of a choreography control device. In some embodiments, the choreography changes may be manually input by a choreographer in real time. In some embodiments, the choreography changes may be made based on a programmed timing schedule or may be triggered by the occurrence of predetermined events.

Further features and aspects of the present invention are explained in greater detail hereinafter with reference to specific embodiments illustrated in the accompanying drawings, wherein like elements are indicated by like reference designators.

### BRIEF DESCRIPTION OF THE FIGURES

The present invention can be more fully understood by reading the following detailed description together with the accompanying drawings, in which like elements are indicated by like reference designators. The accompanying figures depict certain illustrative embodiments and may aid in understanding the following detailed description. It is to be understood that the present invention is not limited in its application to the details of construction and arrangement of components set forth in the following description of illustrated in the figures. The embodiments depicted are to be understood as exemplary and in no way limiting of the overall scope of the invention. Reference will now be made to the accompanying figures, wherein:

FIG. 1 illustrates an exemplary flowchart of operations for an augmented reality system in accordance with embodiments of the present invention.

FIG. 2 illustrates an exemplary flowchart of sharing/tracking operations for an augmented reality system in accordance with embodiments of the present invention.

FIG. 3 illustrates an exemplary flowchart of operations for an augmented reality system in accordance with embodiments of the present invention.

FIG. 4 illustrates an exemplary environment 400 in which an augmented reality system may operate in accordance with embodiments of the present invention.

FIG. 5 illustrates an exemplary device 500 in which an augmented reality system may operate in accordance with embodiments of the present invention.

### DETAILED DESCRIPTION

Embodiments of the present invention allow for delivering and/or tracking marketing or branding messages within virtual reality or augmented reality constructs. In some embodiments, marketing or branding messages may be delivered via a celebrity, sports figure, other public figure, or character, whether real or fictional.

Embodiments provide a platform for augmented reality where a user initiates an application, for example, at a venue such as a concert or other performance, and captures pictures and/or video with an augmented reality scene in place. The augmented reality scene can be based on an event stage's dimensions, for example, so that any added elements may appear in appropriate proportion to the surroundings. The user can then upload the picture or video to a social media platform or otherwise share the picture or video with friends and/or other users of the social media platform. In some embodiments, the augmented reality platform may include virtual elements within the captured picture or video comprising a marketing or branding message for one or more products or services.

In some embodiments, the augmented reality platform may include virtual reality avatars within the captured picture or video, such as one or more celebrities, characters, sports figures, or the like who are part of or associated with the event, which also comprise a marketing or branding message for one or more products or services.

In some embodiments, the augmented reality platform allows a user to direct a camera of the user's device (which may be currently running the augmented reality platform application) toward a particular object, and if the augmented reality platform recognizes the object, the augmented reality platform may then build an augmented reality scene associated with the object that is captured by the user's device. For example, upon recognizing one or more objects in a camera view, the augmented reality platform may build layers of augmented reality elements that surround and/or overlay the one or more objects in a captured image or video.

When the picture or video is created, tracking indicia is embedded in the picture or video, for example, by embedding a tracking pixel or pixels within one or more images image. Using the embedded tracking indicia, the augmented reality picture or video can be tracked as it is shared across social media or among users, for example tracking how the picture or video is shared, where the picture or video is shared, or the like. Based on analysis of the tracked sharing of the picture or video, evaluations may be made as to impressions generated by the marketing or branding message, for example, some embodiments may provide marketing analytics using the tracking information.

In some embodiments, the augmented reality platform may include location and/or movement tracking functionality, such as global positioning system (GPS) or triangulation positioning functions, which can identify the position or location of the user device and monitor movement and/or changes in the location of the user device. The augmented reality scene being added to pictures or video can then be modified based on the movement of the user device. In some embodiments, the augmented reality platform may identify when a user is moving forward, backward, sideways, etc. with regard to a view being captured by the user device and may then modify the augmented reality scene as appropriate based on the identified movement. For example, in some instances, the augmented reality scene can change as the user goes closer to or further away from the scene being captured and/or the augmented reality scene can continue to develop as the user walks or pans a user device camera. In some instances, the movement of the user device may be used to trigger special effects or other scene changes, for example, including new virtual objects, animations, images, activity, or the like to be added within the scene.

In some embodiments, the augmented reality platform may include a remote choreography module that allows for an operator (e.g., choreographer) to control changes to augmented reality scenes. For example, in some embodiments, the remote choreography module may allow a choreographer to modify scenes or images (with or without motion) for mobile device users within a specified area, such as within a specific area at a venue or within a designated radius of a controller or other device at a venue. In some embodiments, the choreographer can program such changes to occur manually, based on a timed schedule, and/or based on trigger events.

In various embodiments, the augmented reality platform may control a camera of a user device directly or may operate in conjunction with an existing camera control application of the user device. For example, in some embodiments, the augmented reality platform may control the user device camera operations directly to capture image data and modify the image data with augmented reality elements. In some embodiments, the augmented reality platform may instead receive image data from another camera application on the user device and modify the image data with augmented reality elements.

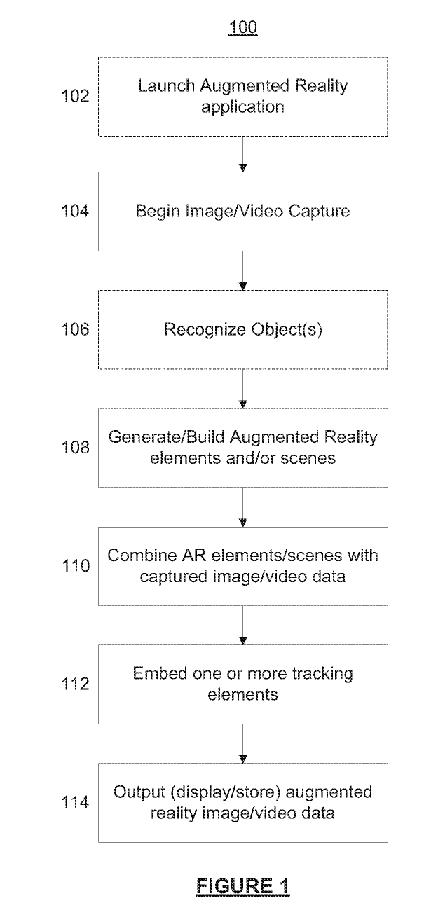

FIG. 1 illustrates an exemplary flowchart of operations 100 for an augmented reality system in accordance with embodiments of the present invention. As shown in block 102, a user may activate/launch an instance of an augmented reality platform application on the user's mobile device when the user desires to capture images, such as at an event, and have the images enhanced with augmented reality elements.

At block 104, the user may direct a camera lens of the user's device toward one or more persons, objects, performance areas, or the like, with a desire to capture images and/or video and the user may provide an indication to the user device to begin capture of images/video. For example, the user may be at a concert with friends and may desire to capture images of the concert, images of one or more performers, images of friends at the concert, and/or the like. The augmented reality platform application may allow the user to capture the desired images/video and have the captured images/video enhanced with augmented reality elements/scenes associated with the concert. For example, the augmented reality platform application may allow images of one or more performers, one or more concert elements, or the like to be overlaid within the user captured images/video.

In some embodiments, the augmented reality platform may provide for object recognition for use in generating the enhanced images/video for the user. For example, at block 106, the augmented reality platform may analyze one or more objects (or persons) in the user device camera field of view to attempt to recognize one or more objects in the field of view. If an object is recognized, the augmented reality platform may then use the recognized object in generating the enhanced images/video, for example building one or more augmented reality layers surrounding or overlaid on the recognized object at block 108.

At block 108, the augmented reality platform may then generate or build layers of augmented reality elements and/or scenes to be overlaid within the user's captured images/video. For example, the augmented reality platform may generate augmented reality elements and/or scenes based on recognized objects in some embodiments. In some embodiments, the augmented reality platform may generate augmented reality elements and/or scenes based on the user's position at a venue and/or the user's movement within the venue. In some embodiments, the augmented reality platform may generate augmented reality elements and/or scenes based on programmed choreography associated with the event being captured, where choreographed elements and/or scene changes may be manually directed by a choreographer using a device controller of the augmented reality platform, may be triggered by a timing schedule, or may be enacted based on other programmed trigger elements.

At block 110, the augmented reality platform application may then combine the augmented reality elements/scenes with the user device captured images and/or video to generate the enhanced images/video. For example, the augmented reality platform may overlay augmented reality layers within the captured image/video, such as surrounding or on top of persons/objects within the image/video. At block 112, the augmented reality platform may embed tracking elements within the enhanced images/video, such as one or more pixels, or the like, encoded for tracking purposes. The augmented reality platform may use such tracking elements for monitoring/capturing sharing data associated with the images/video as the images/video are uploaded and/or shared across social media or other networks.

At block 114, the augmented reality platform application may then output the enhanced images, such as storing the enhanced images/video within a memory of the user device, or outputting the enhanced images/video to a display of the user device.

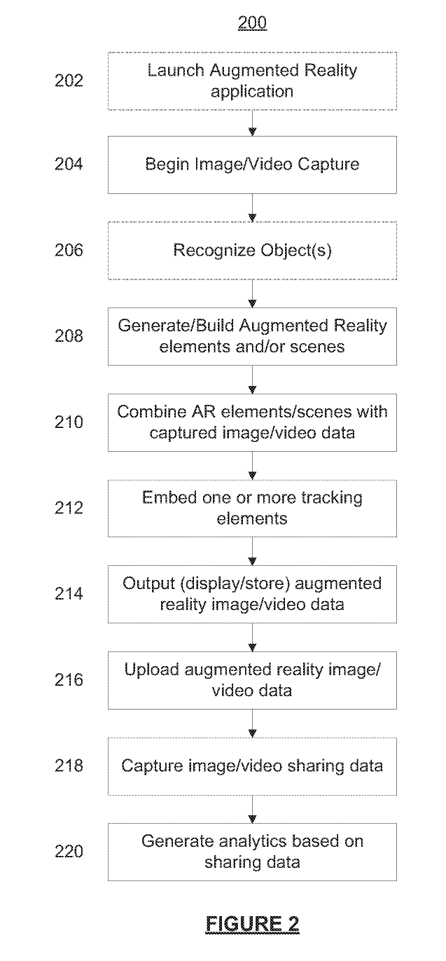

FIG. 2 illustrates an exemplary flowchart of operations 200 for generating and sharing enhanced images/video using an augmented reality system in accordance with embodiments of the present invention. As shown in block 202, a user may activate/launch an instance of an augmented reality platform application on the user's device when the user desires to capture images, such as at an event, and have the images enhanced with augmented reality elements.

At block 204, the user may direct a camera lens of the user's device toward one or more persons, objects, performance areas, or the like, with a desire to capture images and/or video and the user may provide an indication to the user device to begin capture of images/video. For example, the user may be at a concert with friends and may desire to capture images of the concert, images of one or more performers, images of friends at the concert, and/or the like. The augmented reality platform application may allow the user to capture the desired images/video and have the captured images/video enhanced with augmented reality elements/scenes associated with the concert. For example, the augmented reality platform application may allow images of one or more performers, one or more concert elements, or the like to be overlaid within the user captured images/video.

In some embodiments, the augmented reality platform may provide for object recognition for use in generating the enhanced images/video for the user. For example, at block 206, the augmented reality platform may analyze one or more objects (or persons) in the user device camera field of view to attempt to recognize one or more objects in the field of view. If an object is recognized, the augmented reality platform may then use the recognized object in generating the enhanced images/video, for example building one or more augmented reality layers surrounding or overlaid on the recognized object at block 208.

At block 208, the augmented reality platform may then generate or build layers of augmented reality elements and/or scenes to be overlaid within the user's captured images/video. For example, the augmented reality platform may generate augmented reality elements and/or scenes based on recognized objects in some embodiments. In some embodiments, the augmented reality platform may generate augmented reality elements and/or scenes based on the user's position at a venue and/or the user's movement within the venue. In some embodiments, the augmented reality platform may generate augmented reality elements and/or scenes based on programmed choreography associated with the event being captured, where choreographed elements and/or scene changes may be manually directed by a choreographer using a device controller of the augmented reality platform, may be triggered by a timing schedule, or may be enacted based on other programmed trigger elements.

In some embodiments, the augmented reality elements/scenes may comprise one or more marketing or branding messages included within the augmented reality elements/scenes. For example, the augmented reality elements/scenes may include celebrities, characters, images, icons, slogans, logos, etc. associated with or displaying marketing/branding elements for one or more products or services.

At block 210, the augmented reality platform application may then combine the augmented reality elements/scenes with the user device captured images and/or video to generate the enhanced images/video. For example, the augmented reality platform may overlay augmented reality layers within the captured image/video, such as surrounding or on top of persons/objects within the image/video. At block 212, the augmented reality platform may embed tracking elements within the enhanced images/video, such as one or more pixels, or the like, encoded for tracking purposes. The augmented reality platform may use such tracking elements for monitoring/capturing sharing data associated with the images/video as the images/video are uploaded and/or shared across social media or other networks.

At block 214, the augmented reality platform application may then output the enhanced images, such as storing the enhanced images/video within a memory of the user device, or outputting the enhanced images/video to a display of the user device. At block 216, the user may indicate a desire to upload the enhanced images/video to a social media network or other network for sharing with friends. The enhanced images/video is then uploaded/transmitted to the desired social media network or other network for sharing, the uploaded enhanced images/video including the embedded tracking elements.

At block 218, the augmented reality platform may receive data regarding how the enhanced images/video are shared across various social media networks or other networks. For example, the embedded tracking elements may provide for the augmented reality platform to receive data regarding where the enhanced images/video are shared (which social media networks, for example), when the enhanced images/video are shared, how often the enhanced images/video are shared, or the like. At block 220, the augmented reality platform may then generate marketing analytics based on the tracked sharing data to provide data on impressions generated by one or more marketing or branding messages included in the augmented reality elements/scenes. The marketing analytics may then be provided to one or more advertisers, merchants, manufactures, or the like associated with the marketing or branding messages.

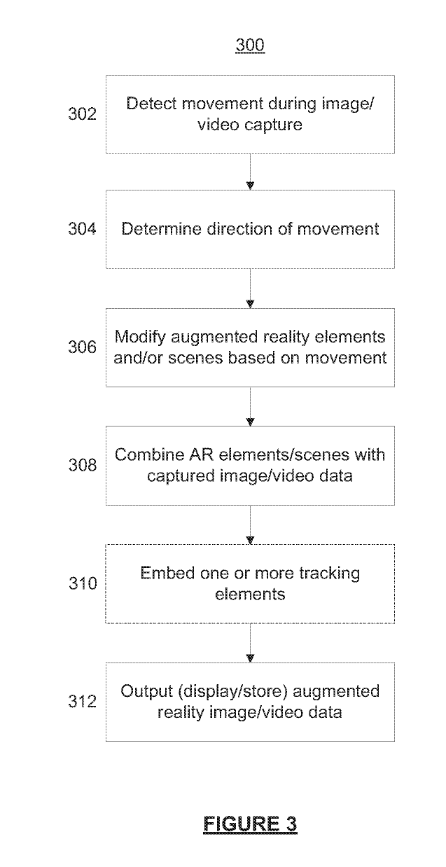

FIG. 3 illustrates an exemplary flowchart of operations 300 for modifying augmented reality elements/scenes during image/video capture using an augmented reality system in accordance with embodiments of the present invention. The user may move around or pan a camera lens during capture of images and/or video in association with the augmented reality platform application. In some embodiments, the augmented reality platform may track such movement and modify a scene based on the movements.

As shown in block 302, the augmented reality platform application may detect that a user is moving or that a user is moving the capture device such as by panning across the user's field of view during the image/video capture. At block 304, the augmented reality platform application may determine the direction of such movement, for example, whether the user is moving forward, backward, sideways, or the like in regard to the camera field of view being captured.

At block 306, the augmented reality platform application may then modify the augmented reality elements/scene based on the determined movement. For example, in some embodiments, the augmented reality scene may be modified as the user goes closer to or further away from the scene being captured and/or the augmented reality scene may continue to be developed as the user walks or pans a user device camera along a particular direction. In some instances, the movement of the user device may be used to trigger special effects or other scene changes, for example, including new virtual objects, animations, images, activity, or the like to be added within the scene. In some embodiments, the augmented reality platform application may only modify the augmented reality elements/scene if the determined movement is above a predetermined threshold, such that small movements may not alter the augmented reality elements/scene.

At block 308, the augmented reality platform application may then combine the augmented reality elements/scenes with the user device captured images and/or video to generate the enhanced images/video. For example, the augmented reality platform may overlay augmented reality layers within the captured image/video, such as surrounding or on top of persons/objects within the image/video. At block 310, the augmented reality platform may embed tracking elements within the enhanced images/video, such as one or more pixels, or the like, encoded for tracking purposes. The augmented reality platform may use such tracking elements for monitoring/capturing sharing data associated with the images/video as the images/video are uploaded and/or shared across social media or other networks.

At block 312, the augmented reality platform application may then output the enhanced images/video, such as storing the enhanced images/video within a memory of the user device or outputting the enhanced images/video to a display of the user device.

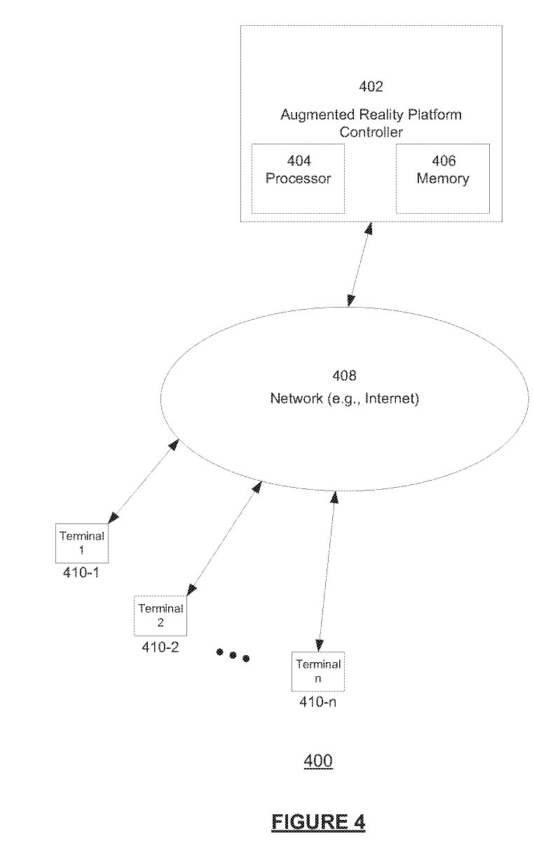

FIG. 4 illustrates an exemplary environment 400 in which an augmented reality system may operate in accordance with embodiments of the present invention. As shown in FIG. 4, an exemplary environment 400 may include an augmented reality platform controller 402 comprising various components, such as one or more processors 404, one or more memories 406, one or more input/output interfaces, one or more communication interfaces, and the like. In some embodiments, the augmented reality platform controller 402 comprises one or more processors 404, which provide means for implementing one or more operations of an augmented reality system in accordance with the present invention. In various embodiments, the one or more memories 406 may include data and computer-executable instructions, which may be provided to the one or more processors 404 for execution, possibly in conjunction with data received for one or more input/output interfaces and one or more communication interfaces, to implement one or more operations of the augmented reality system in accordance with the present invention.

In some embodiments, the augmented reality platform controller 402 may allow for the generation of augmented reality elements, along with programming of choreographed changes to augmented reality scenes, and provide for the transmission of such augmented reality elements and/or scenes to a plurality of terminals 410-1 to 410-n for consumption by end users. In some embodiments, the transmission of the augmented reality elements and/or scenes may be enabled through a network 408, for example the Internet, a proprietary or private network, other public network, and/or the like.

As shown in FIG. 4, the exemplary environment 400 may further include a plurality of terminal 410-1 to 410-n, such as a smartphone, tablet, mobile device, desktop computer, laptop computer, interactive television, or the like, for example. Such terminals may comprise various components, including one or more processors, one or more memories, one or more input/output interfaces, one or more camera interfaces, one or more audio recording interfaces, one or more communication interfaces, and the like. In various embodiments, the one or more memories may include data and computer-executable instructions, which may be provided to the one or more processors for execution, possibly in conjunction with data received for one or more input/output interfaces and one or more communication interfaces, to implement one or more operations of the augmented reality system in accordance with the present invention.

In some embodiments, one or more of the plurality of terminals 410-1 to 410-n may receive transmission of the augmented reality elements and/or scenes, for example through network 408, as part of the augmented reality system in accordance with the present invention. The one or more of the plurality of terminals 410-1 to 410-n may provide for viewing of the augmented reality elements and/or scenes by an end user, as well as provide for capturing of local images or video enhanced with the augmented reality elements and/or scenes. In some embodiments, one or more of the plurality of terminals 410-1 to 410-n may generate augmented reality images/videos based on the received augmented reality elements and/or scenes and images/video captured by the one or more of the plurality of terminals 410-1 to 410-n in accordance with the present invention. The one or more of the terminals 410-1 to 410-n may further provide for transmitting/uploading captured images or video enhanced with the augmented reality elements and/or scenes to a social media platform or other network for sharing with other users.

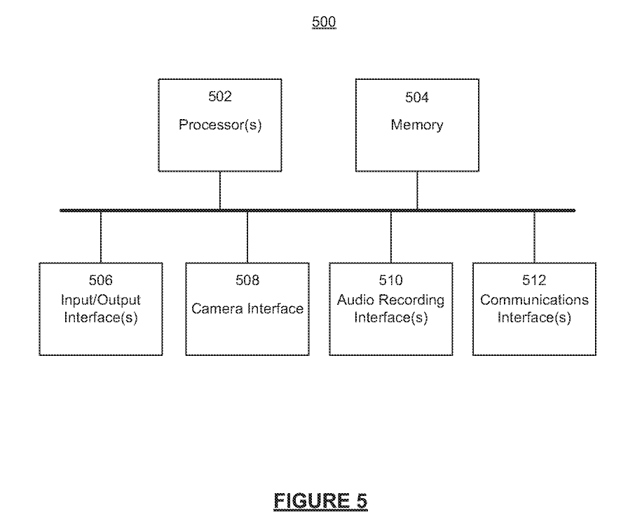

FIG. 5 illustrates an exemplary device 500 in which an augmented reality system may operate in accordance with embodiments of the present invention. Device 500 may be embodied as a smartphone, tablet, smart watch, other mobile device, laptop computer, or the like, for example. As shown in FIG. 5, an exemplary device 500 may include may comprise various components, including one or more processors, one or more memories, one or more input/output interfaces, one or more camera interfaces, one or more audio recording interfaces, one or more communication interfaces, and the like. In various embodiments, the device 500 comprises one or more processors 502, which provide means for implementing one or more operations of an augmented reality system in accordance with the present invention, along with other operations generally comprised in such device.

In various embodiments, the device 500 comprises one or more memories 504 which may include data and computer-executable instructions, which may be provided to the one or more processors 502 for execution, possibly in conjunction with data received for one or more input/output interfaces, one or more camera interfaces, one or more audio recording interfaces, and/or one or more communication interfaces, to implement one or more operations of the augmented reality system in accordance with the present invention.

In various embodiments, the device 500 comprises one or more input/output interfaces 506 which may receive and/or generate audio, visual, tactile, or other input/output signals or data, and which may be operate in conjunction with the one or more processors 502 and the one or more memories 504 to implement one or more operations of the augmented reality system in accordance with the present invention. In some embodiments, the one or more input/output interfaces 506 may provide for viewing of augmented reality elements and/or scenes by an end user, viewing of captured images or video, and or viewing of captured images or video enhanced with the augmented reality elements and/or scenes, in accordance with the present invention.

In various embodiments, the device 500 comprises one or more communication interfaces 512 which may receive and/or transmit signals or data, and which may operate in conjunction with the one or more processors 502 and the one or more memories 504 to implement one or more operations of the augmented reality system in accordance with the present invention. The one or more communication interfaces 512 may facilitate the transmitting/uploading of captured images or video enhanced with the augmented reality elements and/or scenes to a social media platform or other network for sharing with other users.

In various embodiments, the device 500 may comprise one or more camera (image capture) interfaces 508 which may provide for capturing/recording image data, and which may be operated in conjunction with the one or more processors 502 and the one or more memories 504 to implement one or more operations of the augmented reality system in accordance with the present invention. For example, the one or more camera interfaces 508 may provide image data to the augmented reality system for object recognition and/or for enhancement with augmented reality elements and/or scenes.

In various embodiments, the device 500 may further comprise one or more audio recording interfaces 510 which may provide for capturing/recording audio data, and which may be operated in conjunction with the one or more processors 502, the one or more memories 504, and/or the one or more camera interfaces 506 to implement one or more operations of the augmented reality system in accordance with the present invention.

Certain embodiments of the present invention are described above with reference to block and flow diagrams of systems and methods and/or computer program products according to exemplary embodiments of the present invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the present invention.

Such computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more operations specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more operations specified in the flow diagram block or blocks.

Embodiments of the present invention may provide for a computer program product, comprising a non-transitory computer-usable medium having a computer-readable program code or program instructions embodied therein, said computer-readable program code adapted to be executed to implement one or more operations specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the operations specified in the flow diagram block or blocks.

Accordingly, blocks of the block diagrams and flow diagrams support combinations of means for performing the specified operations, combinations of elements or steps for performing the specified operations and program instruction means for performing the specified operations. It will also be understood that each block of the block diagrams and flow diagrams, and combinations of blocks in the block diagrams and flow diagrams, can be implemented by special-purpose, hardware-based computer systems that perform the specified operations, elements or steps, or combinations of special-purpose hardware and computer instructions.

It should be understood that the specific embodiments of the present invention shown and described herein are exemplary only, and the present invention is not to be limited to the disclosed embodiments. Numerous variations, changes, substitutions, modifications and equivalent arrangements will occur to those skilled in the art without departing from the spirit and scope of the present invention. Accordingly, it is intended that all subject matter described herein and shown in the accompanying figures be regarded as illustrative only, and not in a limiting sense. Although specific terms are employed herein, they are used in a generic and descriptive sense only and not for purposes of limitation.

1. A device comprising:
at least one processor; and
at least one memory comprising computer program instructions, the computer program instructions when executed by the at least one processor, causing the device to:
capture image data of a scene;
generate augmented reality elements based in part on the captured image data;
enhance the captured image data with the augmented reality elements;
embed one or more tracking elements in the enhanced image data;
output the enhanced image data with the one or more embedded tracking elements; and
transmit the enhanced image data with the one or more embedded tracking elements to one or more social networks for sharing,
wherein the one or more embedded tracking elements provide for capturing data in regard to how the enhance image data is shared across the one or more social networks.

2. The device according to claim 1 wherein the augmented reality elements comprise one or more marketing messages.

3. (canceled)

4. The device according to claim 1 wherein the one or more embedded tracking elements comprise one or more encoded pixels within the enhanced image data.

5. (canceled)

6. The device according to claim 1 further comprising the computer program instructions when executed by the at least one processor, causing the device to:
detect movement of the device during image data capturing;
modify augmented reality elements based in part on the detected movement; and
enhance the captured image data with the modified augmented reality elements.

7-10. (canceled)

11. A method comprising:
capturing image data of a scene;
in response to capturing the image data, generating augmented reality elements based in part on the captured image data;
automatically enhancing the captured image data with the augmented reality elements;
automatically embedding one or more tracking elements in the enhanced image data such that the captured image data and the enhanced image data is not available without the one or more embedded tracking elements; and
outputting the enhanced image data with the one or more embedded tracking elements,
wherein the one or more embedded tracking elements provide for capturing data in regard to how the enhanced image date is shared across one or more social media networks.

12. The method according to claim 11 wherein the augmented reality elements comprise one or more marketing messages.

13. (canceled)

14. The method according to claim 11 wherein the one or more embedded tracking elements comprise one or more encoded pixels within the enhanced image data.

15. The method according to claim 11 further comprising:
transmitting the enhanced image data with the one or more embedded tracking elements to the one or more social networks for sharing.

16. The method according to claim 11 further comprising:
detecting movement of the device during image data capturing;
modifying augmented reality elements based in part on the detected movement; and
enhancing the captured image data with the modified augmented reality elements.

17. The method according to claim 11 further comprising:
receiving choreography changes during image data capturing;
modifying augmented reality elements based in part on the choreography changes; and
enhancing the captured image data with the modified augmented reality elements,
wherein the choreography changes are contemporaneously transmitted from a choreography control device to a plurality of devices.

18. The method according to claim 17 wherein the choreography control device transmits the choreography changes based in part on the device being located within a specified distance from the choreography control device.

19. The method according to claim 18 wherein the choreography control device transmits the choreography changes in response to user instructions received by the choreography control device.

20. The method according to claim 17 wherein the choreography control device transmits the choreography changes in accordance with one or more pre-programmed event triggers.

21-22. (canceled)

23. The method according to claim 11, wherein
the augmented reality elements comprise the one or more tracking elements, and
the automatically enhancing the captured image data with the augmented reality elements automatically embeds the one or more tracking elements within the enhanced image data.

24. The method according to claim 11, wherein the one or more embedded tracking elements further provide for capturing data indicative of how often the enhanced image data is shared.

25. The method according to claim 11, wherein
the scene comprises a concert; and
the augmented reality elements comprise an image of one or more performers at the concert.

26. The method according to claim 11 further comprising:
receiving a sequence of choreography changes during image data capturing;
for each choreography change of the sequence of choreography changes, modifying the augmented reality elements based on the choreography change; and
enhancing the captured image data with the modified augmented reality elements.

27. A choreography control device comprising:
at least one processor; and
at least one memory comprising computer program instructions, the computer program instructions when executed by the at least one processor, causing the choreography control device to:
generate augmented reality elements, the augmented reality elements comprising one or more tracking elements; and
transmit, to a plurality of external devices, the generated augmented reality elements as choreography changes,
wherein the plurality of external devices are configured to enhance captured image data with the generated augmented reality elements.

28. The choreography control device according to claim 27, wherein choreography control device is configured to transmit the generated augmented reality elements to the plurality of external devices based, in part, on the plurality of external device being located within a distance from the choreography control device.

29. The choreography control device according to claim 27, wherein the computer, program instructions when executed by the at least one processor, further cause the choreography control device to receive user instructions to generate changed augmented reality elements and transmit the changed augmented reality elements to the plurality of external devices in real time.

30. The device according to claim 27, wherein the computer, program instructions when executed by the at least one processor, cause the choreography control device to transmit the generated augmented reality elements according to a pre-programmed timing schedule.
